(19) United States
(12) Patent Application Publication
(10) Pub. No.: US 2024/0372582 A1
(43) Pub. Date: Nov. 7, 2024

(54) User Equipments (UEs) Correlation Matrix Estimation Based on Channel State Information-Reference Signals (CSI-RS)

(71) Applicant: Parallel Wireless, Inc., Nashua, NH (US)

(72) Inventors: Ori Shmuel, Herzliya (IL); Guy Holtzman, Tel Aviv (IL); Erez Biton, Tel Aviv (IL); Nimrod Gradus, Givatayim (IL)

(21) Appl. No.: 18/310,533

(22) Filed: May 1, 2023

Related U.S. Application Data
(60) Provisional application No. 63/336,372, filed on Apr. 29, 2022.

(51) Int. Cl. H04B 7/0456; H04B 7/06

(52) U.S. Cl. CPC H04B 7/0456; H04B 7/0617; H04B 7/0626

(57) ABSTRACT

In one embodiment, a method includes transmitting a plurality of beamformed reference signals using a corresponding plurality of beamforming precoders; receiving from each of the plurality of UEs a signal quality metric for at least a subset of the plurality of beamformed reference signals; determining a beam-specific cross-correlation for pairs of the plurality of UEs using the signal quality metrics; determining one or more scheduling groups of UEs from the plurality of UEs based on the beam-specific cross-correlation for pairs of the plurality of UEs; and allocating a set of time-frequency resource elements to two or more UEs selected from one of the determined scheduling groups.

### CROSS-REFERENCE TO RELATED APPLICATIONS

The present application claims priority under 35 U.S.C. § 119 (c) to U.S. Provisional Patent Application No. 63/336,372, having the same title as the present disclosure and filed Apr. 29, 2022, which is hereby incorporated by reference in its entirety for all purposes. In addition, the present application hereby incorporates by reference U.S. Pat. App. Pub. Nos. US20210297131A1, US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and Ser. No. 15/713,584 (PWS-71850US03). This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019.

### BACKGROUND

Channel correlation between users can significantly affect the system performance in Multi-User Multiple-Input Multiple-Output (MU-MIMO) systems. Channel correlation between users affects performance. Some users are more suitable to be scheduled together. A brute force approach can be used to get detailed specification of channels for each user SRS in the uplink (but this is very expensive). It is desirable to achieve low correlation between all UE pairs in the group.

Channel State Information Reference Signals (CSI-RS) were introduced in LTE release 10 and onward for channel sounding and measuring the characteristics of a radio channel, and cover channel state information for reference signals that are not transmitted continuously and that are also capable of up to 8-layer spatial multiplexing. CSI-RS is used in both 4G LTE and 5G. In 5G NR. CSI-RS is also used for beam management and mobility in the connected mode.

### SUMMARY

In one embodiment, a method includes transmitting a plurality of beamformed reference signals using a corresponding plurality of beamforming precoders; receiving from each of the plurality of UEs a signal quality metric for at least a subset of the plurality of beamformed reference signals; determining a beam-specific cross-correlation for pairs of the plurality of UEs using the signal quality metrics; determining one or more scheduling groups of UEs from the plurality of UEs based on the beam-specific cross-correlation for pairs of the plurality of UEs; and allocating a set of time-frequency resource elements to two or more UEs selected from one of the determined scheduling groups.

In another embodiment a system includes a base station in communication with a plurality of UEs, wherein the base station transmits a plurality of beamformed reference signals using a corresponding plurality of beamforming precoders to the UEs. In response the base station receives from each of the plurality of UEs a signal quality metric for at least a subset of the plurality of beamformed reference signals. The base station determines a beam-specific cross-correlation for pairs of the plurality of UEs using the signal quality metrics and determines one or more scheduling groups of UEs from the plurality of UEs based on the beam-specific cross-correlation for pairs of the plurality of UEs. The base station then allocates a set of time-frequency resource elements to two or more UEs selected from one of the determined scheduling groups.

### BRIEF DESCRIPTION OF THE DRAWINGS

FIG. 1A and FIG. 1B are schematic diagrams of channel state information reference signals (CSI-RSes), in accordance with some embodiments.

FIG. 2 is a schematic diagram of multiple CSI-RSes in situ, in accordance with some embodiments.

FIG. 3 is a schematic diagram of UEs returning CSI-RS information, in accordance with some embodiments.

FIG. 4 is a schematic call flow reflecting CSI-RS communications, in accordance with some embodiments.

FIG. 5 is a schematic diagram of a representative transceiver array, in accordance with some embodiments.

FIG. 6 is a schematic diagram of a network architecture configured to provide CSI-RS correlation matrix estimation, in accordance with some embodiments.

### DETAILED DESCRIPTION

LTE Release 8 and prior used cell-specific reference signals (CRS). These signals were “always-on” signals and were transmitted over the entire bandwidth over the entire cell area. However, this approach was not desirable for 5G in particular, given 5G's requirement of variable numerologies and greater bandwidth. LTE Release 10 and onward introduced the CSI-RS. This signal is no longer always-on, and as a result it is necessary for some configuration to be performed so that the UE can obtain a specific set of CSI-RS. 5G New Radio (NR) reused CSI-RS and further extended it to provide support for beam management and mobility. This disclosure contemplates the use of the methods and systems described herein for both 4G LTE and 5G NR, and any portions of the disclosure that refer to either 4G or 5G shall be read as also including their counterparts in 5G or 4G, as appropriate.

CSI-RS supports up to 32 antenna ports, with a single-port CSI-RS occupying a single RE. A CSI-RS is configured on a per-device basis, but other devices may share it. The CSI-RS may be located anywhere, not with any CORSET, DM-RS associated with PDSCH, and SSB. CSI-RS resource sets are configured to include one or several CSI-RS, and some properties apply to the resource set, such as periodicity.

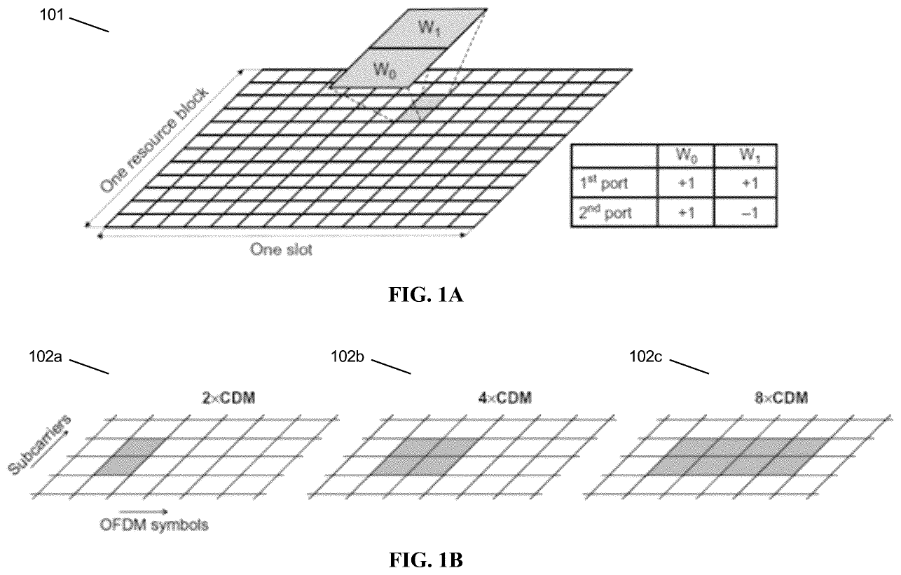

FIG. 1A and FIG. 1B are schematic diagrams of channel state information reference signals (CSI-RSes), in accordance with some embodiments. Depending on the antenna port, different arrangements are possible. In a single-port CSI-RS, a single resource element (RE) is occupied. In FIG. 1A, a 2 per-antenna port CSI-RS is shown, occupying two resource elements in a single slot. This is because in a multi-port CSI-RS, two REs are used since it is a multiple orthogonally transmitted per-antenna-port CSI-RS, sharing the overall set of REs assigned for the configured multi-port CSI-RS. Sharing can be based on combinations of: Code domain sharing CDM (different orthogonal patterns), Frequency Domain Sharing FDM (Different subcarriers within an OFDM symbol) or Time Domain Sharing TDM (Different OFDM symbols within a slot). FIG. 1B shows that an N-port CSI-RS occupies a total of N REs, with a flexible structure when N>2.

To prevent scheduling together highly correlated UEs on the same RBs and to reduce complexity of real time decisions it is beneficial to have groups of UEs which have low correlation value between all UEs pairs of the group.

We can define a correlation measure between two UEs (assuming single antenna UEs):

$${ρ}_{ij} = \frac{\vert {h}_{i} {h}_{j}^{H} \vert}{‖ {h}_{i} ‖ ‖ {h}_{j}^{H} ‖} .$$

Given the above measure for all UEs pairs in the system one can design UE grouping for MU-MIMO transmission to boost network performance.

However, to acquire such information, e.g., Channel estimation for all UEs based on SRS reception, O(UEs\hat{ }2) computations should be computed either in an estimation unit (followed by forwarding the correlation metrics to grouping unit), or in grouping unit (given the uncompressed channel estimates). This is expensive.

To decouple the grouping from the estimation we suggest using precoded CSI-RS along with UEs feedback to generate a quantized correlation matrix, i.e., the desired metric between the UEs. This is done as follows.

Assume symmetric channel for UL/DL, although the systems and methods herein can be enhanced for channel estimation and correlation of UL and DL separately, in some embodiments. We can separate the users we wish to serve in a multi-user manner—employ some bandwidth part and partition. Rather than focusing on bandwidth, correlation between all the users can instead be obtained over time.

Usually in 5G CSI-RS Is used to get CQI and other CSI information. Not defining a very narrow beam but a wide broadcast. Then, users estimate what they are receiving and return back what channel precoding the BS should employ. Instead of waiting for SRS, we can rely on user reporting, and send reference signals. The UEs will receive and measure these reference signals; each reference signal has a specific beam; we can measure received power and/or CQI over this beam; we can then run a correlation metric between all pairs of users and perform a grouping algorithm on that. The grouping algorithm is left to the reader, as a number of algorithms are known in the art. A metric can be selected for maximization, e.g., throughput; in one embodiment a k-clustering algorithm may be used. Once the UEs are segmented into groups, each group of users can be handled together, by, for example, scheduling them together on the same resources.

We are configuring CSI-RS signals in a periodic or aperiodic manner, in some embodiments.

In a first exemplary scenario, a BS with 4 antennas, single-port CSI-RS, therefore we need a precoder of dimension 4×1. Effective channel of H×W (could be a scalar depending on number of UE antennas).

In some embodiments, the base station aggregates received information from all users-UE measurement, CQI, Rank indicator Weighted CQI, RSRP, etc. RSRP is preferred as it is reduces required computation, in some embodiments. Assuming BS transmitting on >1 port, and UE has 1 antenna, then UE will have a hard time; this could result in a wider beam toward a certain direction. This outcome, which is undesirable, can be controlled or reduced by the present disclosure and we can maximize number of beams.

In a second exemplary scenario, a BS, 4 antennas, 4 UEs spread apart, with 2 vectors with 4 elements. As the inner product or correlation coefficient will be 0 if they are well spread apart, this is what we are trying to find with this method. If you take a precoder that exactly contains the channel coefficient for each user, you get 2 beams. Very low power on any overlapping portion of the beams, which is desirable. Note that we don't need to collect all the SRSes to reach the desired scenario.

In some embodiments, a subset of all users can be used for deriving the initial segmentations or groups, and then other users can be evaluated to determine whether they should belong to one of the initial groups.

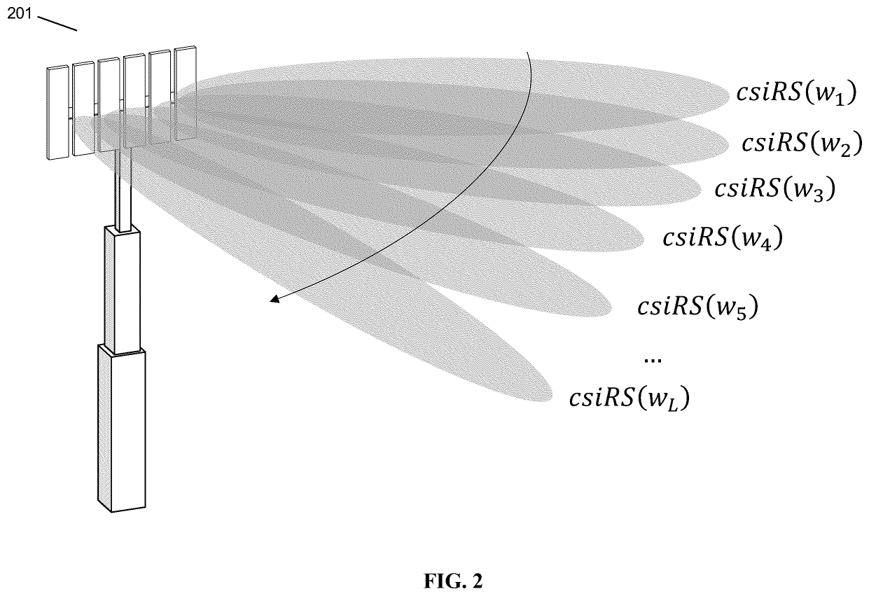

FIG. 2 is a schematic diagram of multiple CSI-RSes in situ, in accordance with some embodiments. FIG. 2 shows wherein the base station (BS) transmits L precoded CSI-RSs, namely, {csiRS(wᵢ)}ᵢ₌₁^{L}. Each configured CSI-RS corresponds to a channel. The UEs receive these signals and respond with feedback.

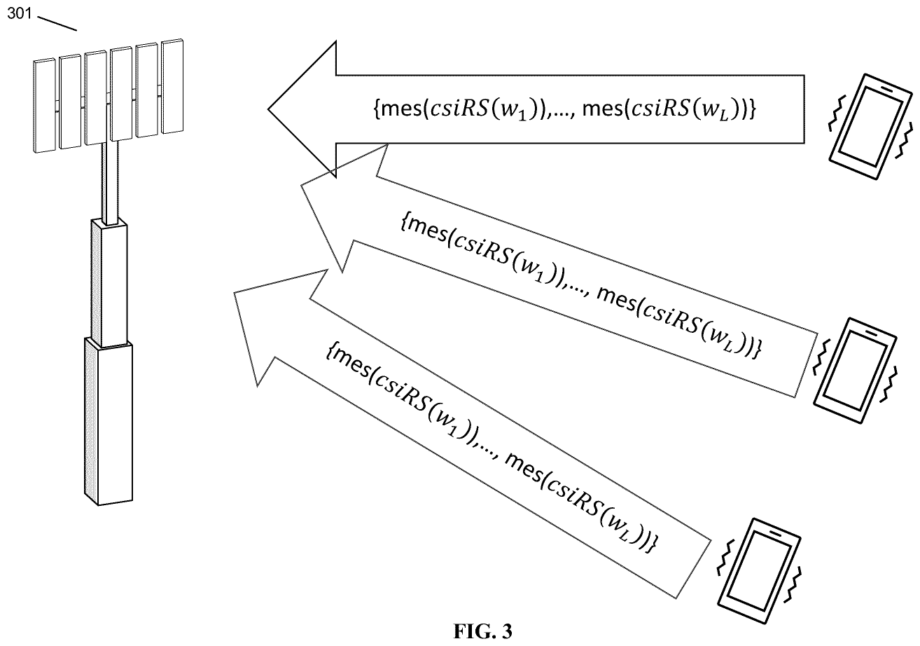

FIG. 3 is a schematic diagram of UEs returning CSI-RS information, in accordance with some embodiments. UEs feedback measurements on the L CSI-RSs are shown. Each UE feedback a vector of length L with measurement on all CSI-RSs, namely, {mes(csiRS(wᵢ))}ᵢ₌₁^{L}. The measurements can be based on any subset of {PMI, CQI, RI, RSRP}, in some embodiments. Then the measurements are decoded at the base station (or in a virtual base station or cloud base station) and grouping is performed.

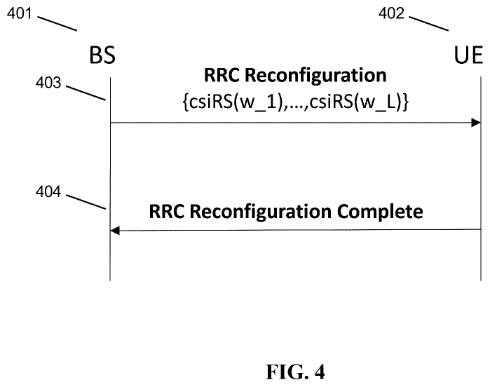

FIG. 4 is a schematic call flow reflecting CSI-RS communications, in accordance with some embodiments. In FIG. 4, we show a BS configuring all UEs in the cell to measure a set of CSI-RS, as depicted in FIG. 3.

Table 1 shows how the BS aggregates received feedback.

TABLE 1

| | csiRS(w₁) | csiRS(w₂) | csiRS(w₃) | . . . | csiRS(W_{L}) | Vector notation |
|---|---|---|---|---|---|---|
| UE#1 | mes(csiRS(w₁)) | mes(csiRS(w₂)) | mes(csiRS(w₃)) | . . . | mes(csiRS(w_{L})) | u₁ |
| UE#2 | mes(csiRS(w₁)) | mes(csiRS(w₂)) | mes(csiRS(w₃)) | . . . | mes(csiRS(w_{L})) | u₂ |
| . . . | . . . | . . . | . . . | . . . | . . . | |
| UE#K | mes(csiRS(w₁)) | mes(csiRS(w₂)) | mes(csiRS(w₃)) | . . . | mes(csiRS(w_{L})) | u_{K} |

Based on these measurements BS calculates correlation matrix, shows in Table 2.

TABLE 2

| | UE#1 | UE#2 | . . . | UE#K |
|---|---|---|---|---|
| UE#1 | u₁ u₁^{T} | u₁ u₂^{T} | . . . | u₁ u_{K}^{T} |
| UE#2 | u₂ u₁^{T} | u₂ u₂^{T} | . . . | u₂ u_{K}^{T} |
| . . . | . . . | . . . | . . . | . . . |
| UE#K | u_{K} u₁^{T} | u_{K} u₂^{T} | . . . | u_{K} u_{K}^{T} |

### Example

BS with 4 antennas, single-port CSI-RS, therefore we need a precoder of dimension 4×1. Effective channel of H×W (could be a scalar depending on number of UE antennas). BS aggregate received information from all users-UE measurement. CQI, Rank indicator and weighted CQI.

Basic RSRP will suffice and will be computationally easier; complex computation to use anything else. Assuming BS transmits on more than one port, and the UE has a single antenna, then UE will have a hard time. Could result in a wider beam toward a certain direction, which is undesirable, we want to maximize number of beams.

Another basic example scenario BS, 4 antenna, 4 UEs spread apart. 2 vectors with 4 elements. In this example, the inner product or correlation coefficient will be 0 if they are well spread apart—this is what we are trying to find with this method. If you take a precoder that exactly contains the channel coefficient for each user, you get 2 beams. Very low power on any overlapping portion of the beams. We don't need to collect all the SRSes.

In a particular embodiment of a method for providing a UEs correlation matrix estimation based on CSI-RS, the method includes transmitting a plurality of beamformed reference signals using a corresponding plurality of beamforming precoders; receiving from each of the plurality of UEs a signal quality metric for at least a subset of the plurality of beamformed reference signals; determining a beam-specific cross-correlation for pairs of the plurality of UEs using the signal quality metrics; determining one or more scheduling groups of UEs from the plurality of UEs based on the beam-specific cross-correlation for pairs of the plurality of UEs; and allocating a set of time-frequency resource elements to two or more UEs selected from one of the determined scheduling groups.

The method may further include transmitting data to the two or more UEs selected from one of the scheduling groups by simultaneously using the set of time-frequency resource elements to encode data for each of the different UEs using different beamforming precoders.

The method may further include wherein the signal quality metrics comprise a metric selected from the group consisting of beam-specific signal strength, and another metric.

The method may further include wherein determining one or more scheduling groups of UEs comprises identifying, for each scheduling group, a set of UEs that have mutual pair-wise cross-correlation values below a predetermined threshold.

The method may further include instructing a plurality of UEs to measure a plurality of beamformed reference signals.

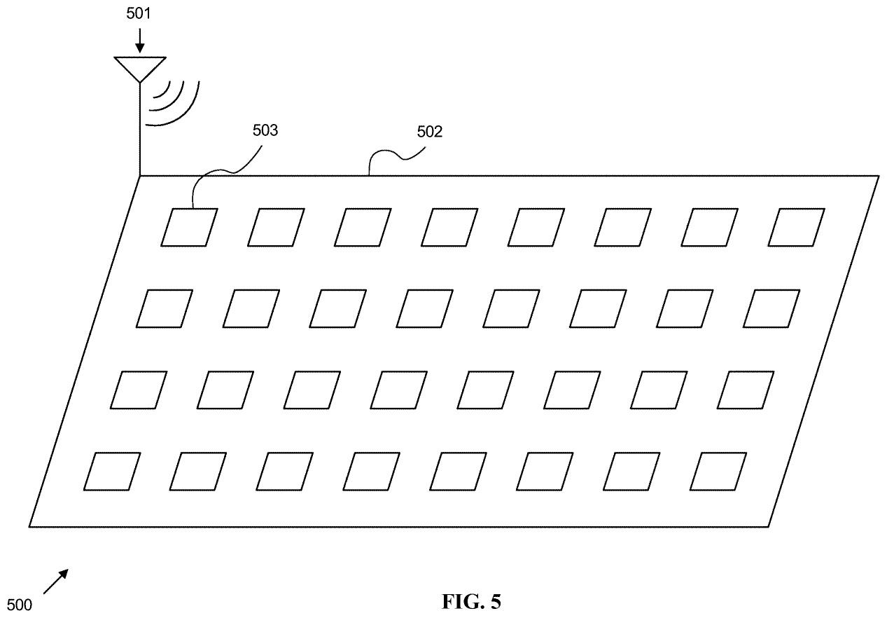

FIG. 5 shows an exemplary antenna array assembly 500 suitable for implementing the present disclosure. Antenna 501 directs signals into the antenna array 502, which includes individual antennas 503, and which provides processing. Further detail regarding the antenna shown in FIG. 5 can be found in US20210297131A1, which is hereby incorporated by reference. Another antenna could be used, such as a standard LTE or 5G NR antenna, in some embodiments. The antenna could be active or passive, in some embodiments. The antenna could be coupled to an offboard or cloud-based baseband, in some embodiments.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided with Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of a processor for reconfiguration.

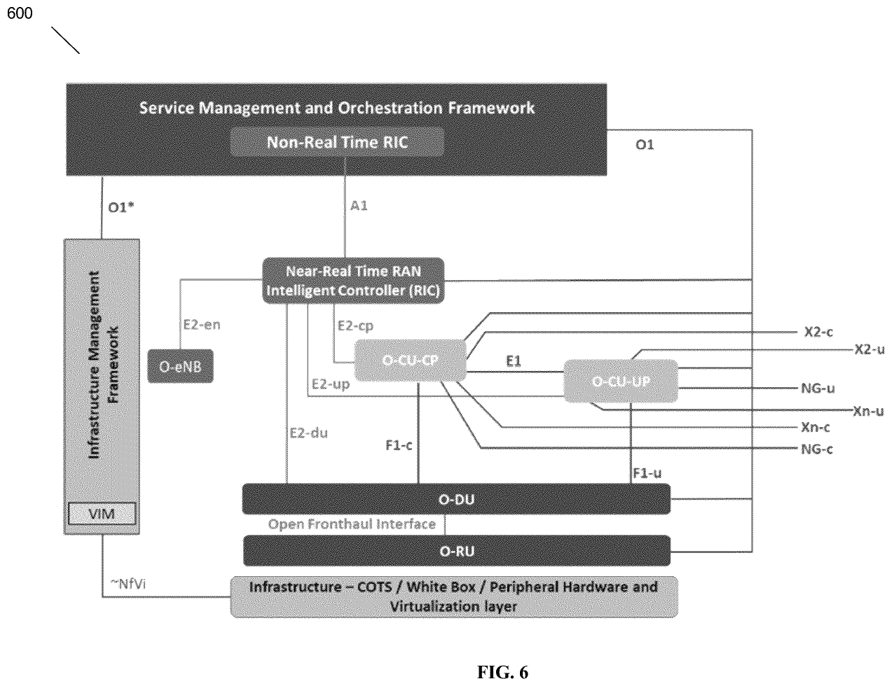

FIG. 6 shows is a schematic diagram of an Open RAN 4G/5G deployment architecture, in accordance with some embodiments. The O-RAN deployment architecture includes an O-DU and O-RU, which together comprise a 5G base station in the diagram as shown. The O-CU-CP (central unit control plane) and O-CU-UP (central unit user plane) are ORAN-aware 5G core network nodes. An ORAN-aware LTE node, O-eNB, is also shown. As well, a near-real time RAN intelligent controller is shown, in communication with the CU-UP, CU-CP, and DU, performing near-real time coordination As well, a non-real time RAN intelligent controller is shown, receiving inputs from throughout the network and specifically from the near-RT RIC and performing service management and orchestration (SMO), in coordination with the operator's network (not shown). The ORAN-aware nodes may provide 4G and 5G base stations in accordance with the description found herein.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

The protocols described herein have largely been adopted by the 3GPP as a standard for the upcoming 5G network technology as well, in particular for interfacing with 4G/LTE technology. For example, X2 is used in both 4G and 5G and is also complemented by 5G-specific standard protocols called Xn. Additionally, the 5G standard includes two phases, non-standalone (which will coexist with 4G devices and networks) and standalone, and also includes specifications for dual connectivity of UEs to both LTE and NR (“New Radio”) 5G radio access networks. The inter-base station protocol between an LTE eNB and a 5G gNB is called Xx. The specifications of the Xn and Xx protocol are understood to be known to those of skill in the art and are hereby incorporated by reference dated as of the priority date of this application.

In some embodiments, several nodes in the 4G/LTE Evolved Packet Core (EPC), including mobility management entity (MME), MME/serving gateway (S-GW), and MME/S-GW are located in a core network. Where shown in the present disclosure it is understood that an MME/S-GW is representing any combination of nodes in a core network, of whatever generation technology, as appropriate. The present disclosure contemplates a gateway node, variously described as a gateway, HetNet Gateway, multi-RAT gateway, LTE Access Controller, radio access network controller, aggregating gateway, cloud coordination server, coordinating gateway, or coordination cloud, in a gateway role and position between one or more core networks (including multiple operator core networks and core networks of heterogeneous RATs) and the radio access network (RAN). This gateway node may also provide a gateway role for the X2 protocol or other protocols among a series of base stations. The gateway node may also be a security gateway, for example, a TWAG or ePDG. The RAN shown is for use at least with an evolved universal mobile telecommunications system terrestrial radio access network (E-UTRAN) for 4G/LTE, and for 5G, and with any other combination of RATs, and is shown with multiple included base stations, which may be eNBs or may include regular eNBs, femto cells, small cells, virtual cells, virtualized cells (i.e., real cells behind a virtualization gateway), or other cellular base stations, including 3G base stations and 5G base stations (gNBs), or base stations that provide multi-RAT access in a single device, depending on context.

In the present disclosure, the words “eNB,” “eNodeB,” and “gNodeB” are used to refer to a cellular base station. However, one of skill in the art would appreciate that it would be possible to provide the same functionality and services to other types of base stations, as well as any equivalents, such as Home eNodeBs. In some cases Wi-Fi may be provided as a RAT, either on its own or as a component of a cellular access network via a trusted wireless access gateway (TWAG), evolved packet data network gateway (ePDG) or other gateway, which may be the same as the coordinating gateway described hereinabove.

The word “X2” herein may be understood to include X2 or also Xn or Xx, as appropriate. The gateway described herein is understood to be able to be used as a proxy, gateway, B2BUA, interworking node, interoperability node, etc. as described herein for and between X2, Xn, and/or Xx, as appropriate, as well as for any other protocol and/or any other communications between an LTE eNB, a 5G gNB (either NR, standalone or non-standalone). The gateway described herein is understood to be suitable for providing a stateful proxy that models capabilities of dual connectivity-capable handsets for when such handsets are connected to any combination of eNBs and gNBs. The gateway described herein may perform stateful interworking for master cell group (MCG), secondary cell group (SCG), other dual-connectivity scenarios, or single-connectivity scenarios.

In some embodiments, the base stations described herein may be compatible with a Long Term Evolution (LTE) radio transmission protocol, or another air interface. The LTE-compatible base stations may be eNodeBs, or may be gNodeBs, or may be hybrid base stations supporting multiple technologies and may have integration across multiple cellular network generations such as steering, memory sharing, data structure sharing, shared connections to core network nodes, etc. In addition to supporting the LTE protocol, the base stations may also support other air interfaces, such as UMTS/HSPA, CDMA/CDMA2000, GSM/EDGE, GPRS, EVDO, other 3G/2G, legacy TDD, 5G, or other air interfaces used for mobile telephony. In some embodiments, the base stations described herein may support Wi-Fi air interfaces, which may include one of 802.11a/b/g/n/ac/ad/af/ah. In some embodiments, the base stations described herein may support 802.16 (WiMAX), or other air interfaces. In some embodiments, the base stations described herein may provide access to land mobile radio (LMR)-associated radio frequency bands. In some embodiments, the base stations described herein may also support more than one of the above radio frequency protocols, and may also support transmit power adjustments for some or all of the radio frequency protocols supported.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to 5G networks, LTE-compatible networks, to UMTS-compatible networks, or to networks for additional protocols that utilize radio frequency data transmission. Various components in the devices described herein may be added, removed, or substituted with those having the same or similar functionality. Various steps as described in the figures and specification may be added or removed from the processes described herein, and the steps described may be performed in an alternative order, consistent with the spirit of the invention.

This application hereby incorporates by reference, for all purposes, each of the following U.S. patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety. Features and characteristics of and pertaining to the systems and methods described in the present disclosure, including details of the multi-RAT nodes and the gateway described herein, are provided in the documents incorporated by reference.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method comprising:
transmitting a plurality of beamformed reference signals using a corresponding plurality of beamforming precoders;
receiving from each of the plurality of UEs a signal quality metric for at least a subset of the plurality of beamformed reference signals;
determining a beam-specific cross-correlation for pairs of the plurality of UEs using the signal quality metrics;
determining one or more scheduling groups of UEs from the plurality of UEs based on the beam-specific cross-correlation for pairs of the plurality of UEs; and
allocating a set of time-frequency resource elements to two or more UEs selected from one of the determined scheduling groups.

2. The method of claim 1 further comprising transmitting data to the two or more UEs selected from one of the scheduling groups by simultaneously using the set of time-frequency resource elements to encode data for each of the different UEs using different beamforming precoders.

3. The method of claim 1 wherein the signal quality metrics comprise a metric selected from the group consisting of beam-specific signal strength, and another metric.

4. The method of claim 1 wherein determining one or more scheduling groups of UEs comprises identifying, for each scheduling group, a set of UEs that have mutual pair-wise cross-correlation values below a predetermined threshold.

5. The method of claim 1 further comprising instructing a plurality of UEs to measure a plurality of beamformed reference signals.

6. A system comprising:
a base station;
a plurality of UEs in communication with the base station, wherein the base station transmits a plurality of beamformed reference signals using a corresponding plurality of beamforming precoders to the UEs;
the base station then receives from each of the plurality of UEs a signal quality metric for at least a subset of the plurality of beamformed reference signals and determines a beam-specific cross-correlation for pairs of the plurality of UEs using the signal quality metrics, and determines one or more scheduling groups of UEs from the plurality of UEs based on the beam-specific cross-correlation for pairs of the plurality of UEs; and
wherein the base station allocates a set of time-frequency resource elements to two or more UEs selected from one of the determined scheduling groups.
